(19) United States
(12) Patent Application Publication
(10) Pub. No.: US 2012/0032570 A1
(43) Pub. Date: Feb. 9, 2012

(54) FLAP DRIVE SYSTEM

(76) Inventors: Gerald FRIESENECKER, Lauterach (AT); Wolfgang BOHLE, Gotzis (AT)

(21) Appl. No.: 13/274,615

(22) Filed: Oct. 17, 2011

Related U.S. Application Data
(63) Continuation of application No. PCT/AT2010/000162, filed on May 12, 2010.

(30) Foreign Application Priority Data
May 13, 2009 (AT) A 733/2009

(51) Int. Cl. E05F 15/12

(52) U.S. Cl. 312/319.6

(57) ABSTRACT

The invention relates to a flap drive system for a flap which is movably mounted on a furniture carcass, the flap drive system being arranged on a sidewall of the furniture carcass. The flap drive system comprises: a mechanical actuating unit having an actuating arm that can be connected to the flap and an accumulator acting upon the actuating arm, an electric drive, fastened on the mechanical actuating unit, for driving the flap, said electric drive having at least one electric motor, and a gear stage which allows the transmission of force from the electric drive onto the mechanical actuating unit. The gear stage is designed as a separate component and has a housing that is independent from the mechanical actuating unit and the electric drive or an independent mounting plate.

The invention concerns a flap drive system for a flap mounted movably to a furniture carcass, the flap drive system being arranged at a side wall of the furniture carcass, comprising a mechanical actuating unit having an actuating arm which can be connected to the flap and a force storage means acting on the actuating arm and an electric drive fixed to the mechanical actuating unit for driving the flap, the electric drive having at least one electric motor and a transmission stage which permits a transmission of force from the electric drive to the mechanical actuating unit.

Flap drive systems for a flap mounted movably to a furniture carcass are already known and are illustrated for example in WO 2008/134786. The disadvantage there is that this flap drive system is only designed for mechanical actuating units which are sized for same and therefore cannot be mounted to different mechanical actuating units. It is thus necessary to produce, for each mechanical actuating unit, an electric drive which is of specific dimensions for same, and that is linked to high cost levels.

The object of the invention is to overcome the above-described disadvantage and to provide a flap drive system which is improved over the state of the art.

In the flap drive according to the invention that is achieved in that the transmission stage is in the form of a self-contained component having a housing which is independent of the mechanical actuating unit and the electric drive or an independent mounting plate.

In other words there is provided a transmission stage which is not part of the electric drive or the mechanical actuating unit. That transmission stage can be of such dimensions that it can operate independently of the electric drive and the mechanical actuating unit. That has the advantage that different mechanical actuating units can be driven with one electric drive as it is only the transmission stage that has to be appropriately dimensioned, and not the electric drive itself or the mechanical actuating unit. That therefore provides an inexpensive variant for different mechanical actuating systems and electric drives for flap drive systems. Equally it is possible for mechanical actuating units to be subsequently provided with a transmission stage according to the invention and an electric drive, as all necessary adaptations in respect of the electric drive to the mechanical actuating unit can be implemented by means of the transmission stage. If the transmission stage is equipped with a housing it can be particularly easily fitted to the mechanical actuating unit or the electric drive can be easily mounted to the transmission stage.

Further advantageous embodiments of the invention are defined in the appendant claims:

In a further embodiment it has proven advantageous if the transmission of the transmission stage can locally displace the force transmission from the electric drive to the mechanical actuating unit. The transmission stage is thus capable of introducing the force of the electric drive into the mechanical actuating unit at various predeterminable locations.

In that respect it has proven to be advantageous if the transmission of the transmission stage causes an increase or a reduction in the length of the travel path described by a projection of the transmission stage, which transmits the force from the transmission stage to the mechanical actuating unit. The transmission stage is thus capable of driving mechanical actuating units, whose actuating arms have to describe a longer or shorter travel path during the flap opening and closing movement.

In a further embodiment it has proven advantageous if the transmission of the transmission stage can alter, that is to say increase or reduce, the torque from the electric drive to the mechanical actuating unit as in that way it is also possible to advantageously move flaps of differing weight.

In that respect it has been found to be particularly advantageous if the transmission stage has a mounting for the electric drive as in that way the electric drive can be mounted to the transmission stage quickly and in accurate positional relationship.

Equally it has been found to be advantageous if the transmission stage can be fixed to the mechanical actuating unit and/or the furniture carcass as mounting of the transmission stage can thus be effected in different ways. It is equally advantageous if the drive unit can be mounted to the transmission stage after the transmission stage is mounted to the mechanical actuating unit as in that way the transmission stage does not have to be separated from the mechanical actuating unit.

It has proven to be particularly advantageous in that respect if the transmission stage can be fixed to the furniture carcass or the mechanical actuating unit even when the mechanical actuating unit is already mounted to the furniture carcass as it is then not necessary to dismantle the mechanical actuating unit from the furniture carcass to fit the transmission stage.

It has proven advantageous in that respect if the mechanical actuating unit, the transmission stage and the electric drive can respectively be connected together in such a way that their side surfaces lie against each other. It is possible in that way to achieve an extremely compact structure which takes up the minimum amount of space in the furniture carcass.

It has proven particularly advantageous in that respect if the mechanical actuating unit, the transmission stage and the electric drive are adapted to be releasably assembled together. That makes a positive contribution to the maintenance-friendliness of the flap drive system as in that way the entire flap drive system does not have to be replaced if one of the units should be defective.

The article of furniture according to the invention is characterized by at least one flap drive system of the kind described.

Further details and advantages of the present invention are described with reference to the specific description hereinafter. In the drawing:

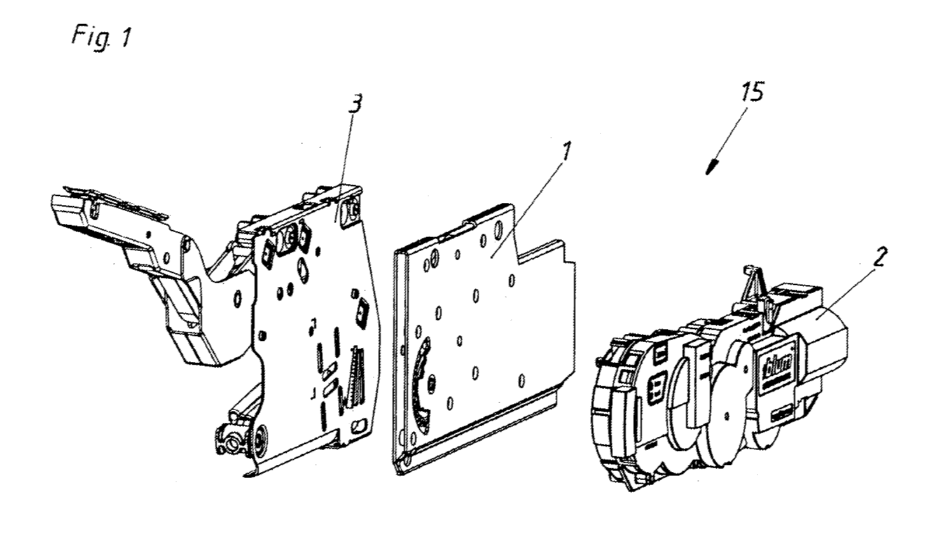

FIG. 1 shows views of an exploded flap drive system according to the invention,

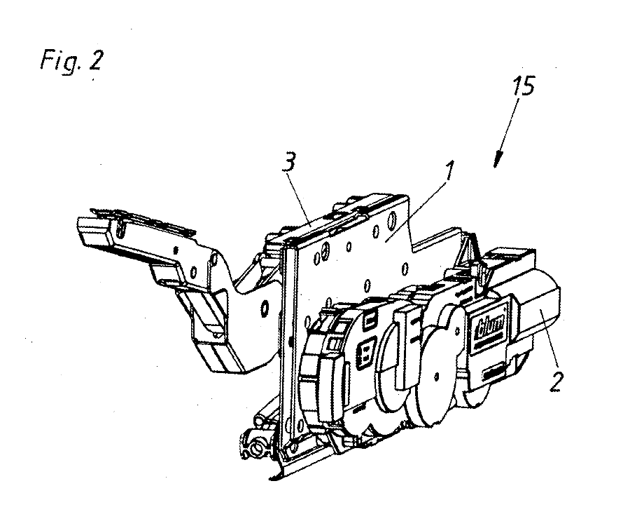

FIG. 2 shows views of an assembled flap drive system according to the invention,

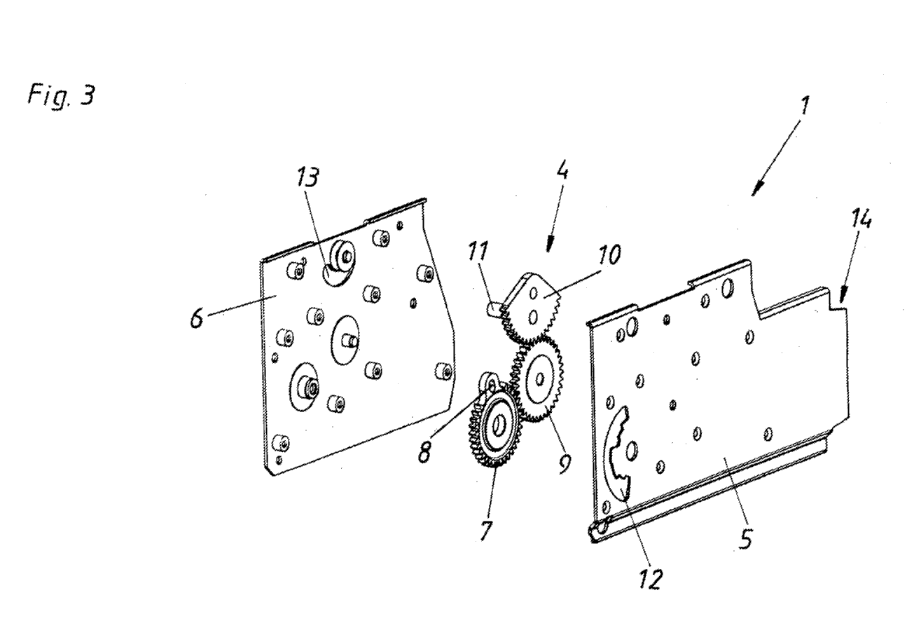

FIG. 3 shows a view of the interior of a transmission stage,

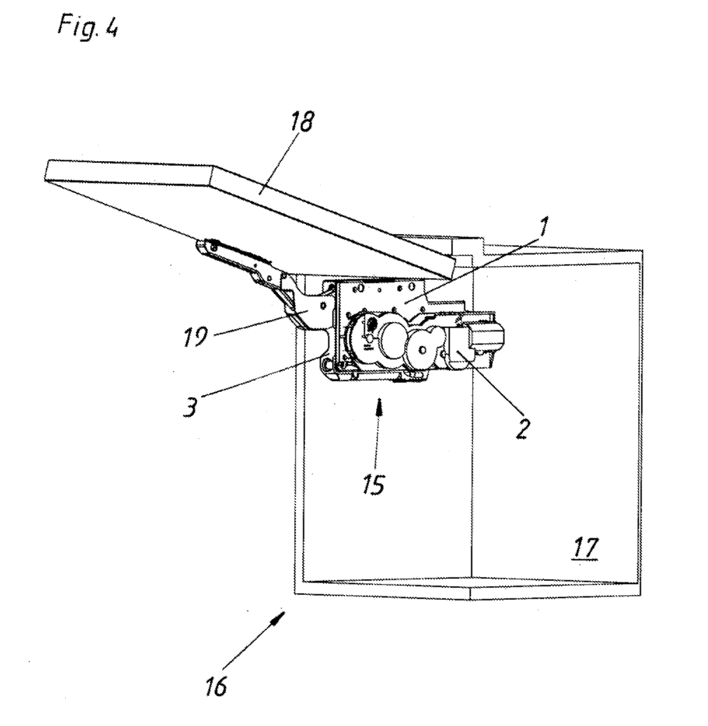

FIG. 4 shows a view of an article of furniture with a flap drive system for moving a furniture flap, and

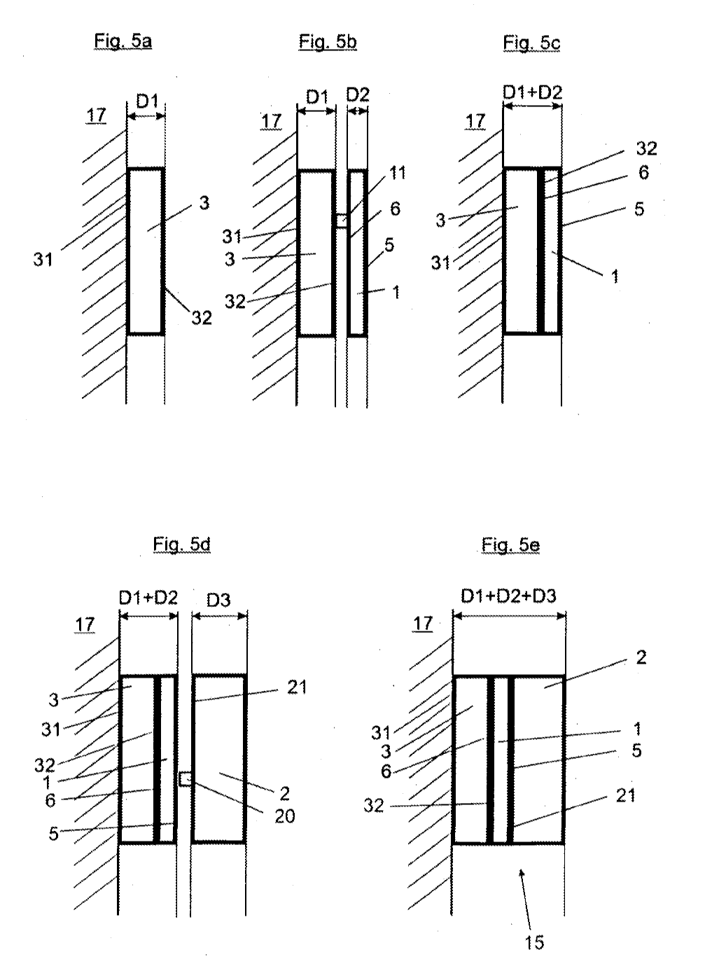

FIGS. 5a through 5e show a diagrammatic view illustrating the procedure of installing and assembling the flap drive system.

FIG. 1 shows a flap drive system 15 comprising a mechanical actuating unit 3, a transmission stage 1 and an electric drive 2. It will be seen from FIG. 1 that the transmission stage 1 represents a self-contained component separate from the mechanical actuating unit 3 and the electric drive 2.

FIG. 2 shows a flap drive system 15 on which the three assemblies—namely the transmission stage 1, the electric drive 2 and the mechanical actuating unit 3—are connected together.

FIG. 3 shows an exploded view of the transmission stage 1 comprising a right-hand housing portion 5 and a left-hand housing portion 6 between which there is a transmission 4. A pin (not shown here) of the electric drive is introduced into the pin receiving means 8 through an opening 12 in the right-hand housing portion 5. The projection 11 in turn acts through the opening 13 of the left-hand housing portion 6 on a corresponding receiving means (not shown) in the mechanical actuating unit 3. The electric drive 2 is mounted to the drive mounting 14 of the transmission stage 1, in which case the above-mentioned pin of the electric drive 2 projects into the pin receiving means 8. The pin of the electric drive 2 drives the mechanical actuating unit by way of the intermediate gear 9 and the projection 11. This embodiment involves both a lateral displacement of the transmission of force to the mechanical actuating unit 3 and also, by suitable dimensioning of the gears (7, 9, 10), an increase or reduction in the torque. The external shape of the drive mounting 14 of the transmission stage 1 ensures that the same electric drive 2 can be used for different mechanical actuating units 3 and also for different transmission stages 1. Suitable dimensioning of the gear 10 and a suitable choice for the position of the projection 11 on the gear 10 make it possible to increase or reduce the length of the travel path covered by the projection 11. It will be appreciated that the transmission stage 1 can also be designed in such a way that there is neither a change in position nor a change in torque due to the transmission stage 1.

FIG. 4 shows a perspective view of an article of furniture 16 having a furniture carcass 17 and a flap 18 movable relative thereto. In the illustrated embodiment the flap 18 is in the form of an upwardly pivotable flap. All other known types of flap can advantageous also be used. At least one flap drive system 15 is to be fixed on a side wall of the furniture carcass 17 for moving the flap 18. The electric drive 2 of the flap drive system 15 acts by way of the transmission stage 1 on the mechanical actuating unit 3. The mechanical actuating unit 3 has an actuating arm 19 which in this embodiment is in the form of a lever mechanism. The flap 18 is movable in further succession by way of the actuating arm 19. It will be appreciated that the actuating arm 19 of the mechanical actuating unit 3 can equally be in the form of a one-piece lever or the mechanical actuating unit 3 could be designed for example with a drive stub to which a further lever arm can be connected to move the flap 18.

FIGS. 5a through 5e show the diagrammatic installation and assembly procedure for a furniture drive system 15 on a side wall of the furniture carcass 17.

As can already be seen from FIGS. 1 and 2 the mechanical actuating unit 3, the transmission stage 1 and the electric drive 2 are formed with flat side walls by way of which they can be connected together.

FIG. 5a shows a possible installation variant in which, as the first step, the mechanical actuating unit 3 is fixed with its left-hand side surface 31 to a side wall of the furniture carcass 17. At the opposite side surface 32 the mechanical actuating unit 3 is of a plate-like configuration (see FIG. 1). The mechanical actuating unit 3 is of a very narrow width D1, in a preferred embodiment being of a width D1 of less than between 2 and 3 cm.

As shown in FIG. 5b the left-hand housing portion 6 of the transmission stage 1—which is also of a plate-shaped configuration—is fixed to the side surface 32 of the mechanical actuating unit 3, the transmission of force being effected by way of the projection 11 (see also FIG. 3). In this case the projection 11 extends into the mechanical actuating unit 3 to such an extent that the side plate 32 of the mechanical actuating unit 3 and the side surface 6 of the transmission stage 1 bear flat against each other (FIG. 5c). As just mentioned in relation to the mechanical actuating unit 3 the transmission stage 1 is also of a flat configuration and in the preferred embodiment is of a width D2 of less than 2 cm.

The right-hand housing portion 5 of the transmission stage 1 is also once again in the form of a flat plate on which is arranged the left-hand side surface 21 of the electric drive 2—also in the form of a flat plate 21 (FIG. 5d). The transmission of force to the transmission stage 1 takes place by way of the pin 20 of the electric drive 2, by the pin 20 of the electric drive 2 projecting into the pin receiving means 8 (not shown, see FIG. 3). Here too once again the pin 20 projects into the transmission stage 1 to such an extent that the plate 21 of the electric drive 2 and the plate 5 of the transmission stage 1 bear flat against each other (FIG. 5e).

The electric drive 2 is in this case also of a very flat construction, of a preferred width D3 of less than between 4 and 5 cm.

That therefore involves an overall width for the flap drive system 15 in the installed condition, which is approximately the same as the width D1 of the mechanical actuating unit 3 plus the width D2 of the transmission stage 1 plus the width D3 of the electric drive 2. That can be achieved in that way as the transmission mechanisms (the pin 20 and the projection 11) project into the corresponding units (transmission stage 1 and mechanical actuating unit 3).

The fact that the transmission stage 1 can be arranged at the mechanical actuating unit 3 and the electric drive 2 at the transmission stage 1, by way of the flat side surfaces 32, 6, 5, 21 thereof, achieves an overall structure which is extremely compact. Because the electric drive 2 can be connected into the transmission stage 1 and the transmission stage 1 into the mechanical actuating unit 3 by means of plug connections, it is further possible to provide that they can be easily released from each other again.

The overall structure of all three units 1, 2 and 3 can thus be arranged in extremely compact fashion at a side wall of a furniture carcass 17 and in that way requires little space in the furniture carcass 17.

Even if the invention has been specifically described by means of the illustrated embodiment it will be appreciated that the subject-matter of the application is not limited to that embodiment. Rather features and modifications which serve to carry the idea of the invention into effect are certainly conceivable and wanted.

### LIST OF REFERENCES

1 transmission stage
2 electric drive
3 mechanical actuating unit
4 transmission
5 right-hand housing portion
6 left-hand housing portion
7 gear of the pin receiving means
8 pin receiving means
9 intermediate gear
10 gear of the projection
11 projection
12 opening for pin of the electric drive
13 opening for projection
14 drive mounting
15 flap drive system
16 article of furniture
17 furniture carcass
18 flap
19 actuating arm
20 pin of the electric drive
21 left-hand side surface of the electric drive
31 left-hand side surface of the mechanical actuating unit
32 right-hand side surface of the mechanical actuating unit
D1 width of the mechanical actuating unit 3
D2 width of the transmission stage 1
D3 width of the electric drive 2

1. A device comprising:
a flap drive system for a flap mounted movably to a furniture carcass, the flap drive system being arranged at a side wall of the furniture carcass, comprising
a mechanical actuating unit having an actuating arm which can be connected to the flap and a force storage means acting on the actuating arm,
an electric drive fixed to the mechanical actuating unit for driving the flap, the electric drive having at least one electric motor, and
a transmission stage which permits a transmission of force from the electric drive to the mechanical actuating unit,
wherein that the transmission stage is in the form of a self-contained component having a housing which is independent of the mechanical actuating unit and the electric drive or an independent mounting plate.

2. The device according to claim 1, wherein that the electric drive has a further transmission stage.

3. The device according to claim 1, wherein that the transmission of force from the electric drive to the mechanical actuating unit can be locally displaced by the transmission of the transmission stage.

4. The device according to claim 1, wherein that the transmission of the transmission stage causes an increase or a reduction in the length of the travel path described by a projection of the transmission stage.

5. The device according to claim 1, wherein that the transmission of the transmission stage causes an increase or reduction in torque from the electric motor to the mechanical actuating unit.

6. The device according to claim 1, wherein that the transmission stage has at least one drive mounting to which the electric drive can be mounted.

7. The device according to claim 1, wherein that the transmission stage is fixed to the furniture carcass.

8. The device according to claim 1, wherein that the transmission stage is fixed to the mechanical actuating unit.

9. The device according to claim 1, wherein that the transmission stage is fixed to the electric drive.

10. The device according to claim 1, wherein that the transmission stage can be fixed to the actuating unit or to the furniture carcass even when the actuating unit is already mounted to the furniture carcass.

11. The device according to claim 1, wherein that the mechanical actuating unit, the transmission stage and the electric drive can respectively be connected together in such a way that their side surfaces lie against each other.

12. The device according to claim 1, wherein that the mechanical actuating unit, the transmission stage and the electric drive are adapted to be releasably assembled together.

13. An article of furniture having a furniture carcass and a flap mounted movably to or in the furniture carcass, with the device according to claim 1, that is arranged on the furniture carcass.
